(19) United States
(12) Patent Application Publication
(10) Pub. No.: US 2015/0061362 A1
(43) Pub. Date: Mar. 5, 2015

(54) BRAKE CONTROL APPARATUS

(71) Applicant: HITACHI AUTOMOTIVE SYSTEMS, LTD., Ibaraki (JP)

(72) Inventors: Masayuki KIKAWA, Aikou-gun (JP); Norikazu MATSUZAKI, Atsugi-shi (JP); Kunihiro MATSUNAGA, Minami Alps-shi (JP); Hiroshi SHIGETA, Atsugi-shi (JP); Kentaro UENO, Atsugi-shi (JP); Hiroshi FURUYAMA, Obihiro-shi (JP)

(21) Appl. No.: 14/469,089

(22) Filed: Aug. 26, 2014

(30) Foreign Application Priority Data
Aug. 30, 2013 (JP) 180389/2013

(51) Int. Cl. B60T 13/66; B60T 13/74; B60T 7/06

(52) U.S. Cl. CPC B60T 13/662; B60T 7/06; B60T 13/745
USPC 303/10; 303/14

(57) ABSTRACT

When a driving force of a drive motor (21) becomes a maximum driving force even in the case where a brake pedal (5) is depressed by a large amount while a vehicle is in a stopped state, a second ECU (33) outputs a valve-closing command to a boost control valve (40, 40′) of an ESC (31) for a left front wheel (FL; front wheel 1L) and a right front wheel (FR; front wheel 1R). In this manner, a hydraulic pressure flowing from a master cylinder (8) through the ESC (31) to each wheel side is not supplied to wheel cylinders (3L, 3R) for the front wheels (1L, 1R) but is supplied only to wheel cylinders (4L, 4R) for rear wheels (2L, 2R). A hydraulic stiffness of the wheel cylinders (3L, 3R, 4L, 4R) is changed by stopping supply of a brake fluid to the wheel cylinders (3L, 3R).

### BACKGROUND OF THE INVENTION

### Technical Field

The present invention relates to a brake control apparatus which is suitably used for applying a braking force to a vehicle.

### BACKGROUND ART

As a brake apparatus to be mounted in a vehicle, the following one is known. Specifically, the brake apparatus includes an input member which is configured to move forward and backward in accordance with an operation of a brake pedal, a piston which is provided movably with respect to the input member to generate a hydraulic pressure in a master cylinder, and an electric booster including a drive motor which move the piston forward and backward based on the operation of the brake pedal to variably control the hydraulic pressure in the master cylinder (for example, see Japanese Patent Application Laid-open Nos. 2012-96649 and 2013-28273).

In the electric booster used in the brake apparatus described above, when the drive motor comes into a full-load state, a reaction force (pedal feeling) generated by the operation of the brake pedal changes to sometimes give a weird pedal feeling to a driver. In Japanese Patent Application Laid-open No. 2012-96649, in order to eliminate the weird pedal feeling, a spring for applying the reaction force when the drive motor comes into the full-load state is provided so as to adjust the change in reaction force. Moreover, as disclosed in Japanese Patent Application Laid-open No. 2013-28273, a hydraulic-pressure rise caused by the operation of the brake pedal is suppressed to suppress a change in the reaction force occurring when the drive motor comes into the full-load state.

According to the related art disclosed in Japanese Patent Application Laid-open No. 2012-96649, the spring for applying the reaction force is additionally provided. As a result, a mechanism of the electric booster becomes disadvantageously complex. On the other hand, the related art disclosed in Japanese Patent Application Laid-open No. 2013-28273 has a problem in that an output hydraulic pressure generated by the operation of the brake pedal, which is started with a predetermined stroke, is lowered. As a result, an operation amount of the brake pedal is disadvantageously increased to generate a necessary output hydraulic pressure.

### SUMMARY OF INVENTION

The present invention has been made to solve the above-mentioned problems of the related art, and therefore has an object to provide a brake control apparatus which has a simple structure and is capable of suppressing a change in reaction force, which occurs when a drive motor comes into a full-load state, without lowering an output hydraulic pressure generated by a pedal operation.

In order to solve the problems described above, the brake control apparatus according to one embodiment of the present invention includes: a master-cylinder pressure control unit configured to control a drive motor configured to pressurize a hydraulic fluid in a master cylinder in accordance with an operation of a brake pedal to which a hydraulic reaction force is transmitted; and a wheel-cylinder fluid supply control unit provided between a wheel cylinder provided to a wheel and the master cylinder, which controls supply of the hydraulic fluid to the wheel cylinder. When a driving force of the drive motor becomes a maximum driving force in a period during which the brake pedal is operated, a hydraulic stiffness of the wheel cylinder has been already increased by the wheel-cylinder fluid supply control unit.

According to one embodiment of the present invention, a change in reaction force, which occurs when the drive motor comes into the full-load state, can be suppressed.

### BRIEF DESCRIPTION OF DRAWINGS

FIG. 1 is an overall configuration diagram of a brake apparatus to which a brake control apparatus according to a first embodiment of the present invention is applied.

FIG. 2 is a circuit block diagram illustrating a circuit configuration of control devices including a first ECU and a second ECU illustrated in FIG. 1.

FIG. 3 is a front view illustrating an external structure of an ESC illustrated in FIG. 1.

FIG. 4 is a characteristic diagram showing the relationship between a pedaling force (F) on and a pedal stroke (S) of a brake pedal.

FIG. 5 is a flowchart illustrating control processing for adjusting a hydraulic stiffness on a downstream side, which is performed by the controller (second ECU) on the ESC side of the master cylinder.

FIG. 6 is a flowchart illustrating control processing for adjusting the hydraulic stiffness on the downstream side according to a second embodiment of the present invention.

FIG. 7 is an overall configuration diagram of a brake apparatus to which a brake control apparatus according to a third embodiment of the present invention is applied.

### DESCRIPTION OF EMBODIMENTS

Now, a brake control apparatus according to embodiments of the present invention is specifically described referring to the accompanying drawings, taking a brake apparatus to be mounted in a four-wheeled automobile as an example.

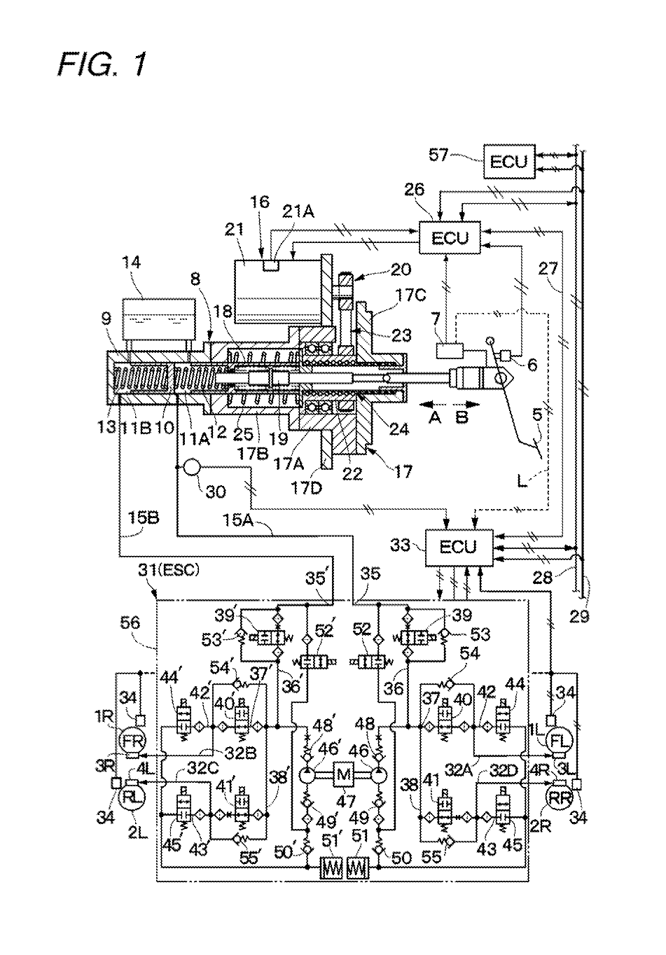

FIGS. 1 to 5 illustrate a first embodiment of the present invention. In FIG. 1, a left front wheel 1L, a right front wheel 1R, a left rear wheel 2L, and a right rear wheel 2R are provided to a lower side of a vehicle body (not shown) constructing a body of a vehicle. A front-wheel side wheel cylinder 3L is provided to the left front wheel 1L, whereas a front-wheel side wheel cylinder 3R is provided to the right front wheel 1R. Similarly, a rear-wheel side wheel cylinder 4L is provided to the left rear wheel 2L, whereas a rear-wheel side wheel cylinder 4R is provided to the right rear wheel 2R. The wheel cylinders 3L, 3R, 4L, and 4R are cylinders of a hydraulic disc brake or drum brake. Each of the wheel cylinders 3L, 3R, 4L, and 4R applies a braking force to each of the wheels (front wheels 1L and 1R and rear wheels 2L and 2R).

A brake pedal 5 is provided on a front side portion of the driver's seat (not shown) of the vehicle body. The brake pedal 5 is operated by a driver to be pedaled in a direction indicated by the arrow A illustrated in FIG. 1 at the time of a brake operation for the vehicle. The brake pedal 5 is provided with a brake switch 6 and a brake sensor 7.

Here, the brake switch 6 detects whether or not the brake operation for the vehicle is performed, and outputs a signal for turning on and off a brake lamp (not shown), for example. In this case, the brake switch 6 is connected to a first ECU 26 described later and outputs a brake lamp switch signal (ON/OFF signal) for detecting the depression of the brake pedal 5 to the first ECU 26. As described later, an ON signal (BSW signal) of the brake lamp switch signal is used as “another start signal” which activates (starts) a system of the first ECU 26.

The brake sensor 7 as an operation-amount detection unit is a stroke sensor which detects a brake operation amount of the brake pedal 5 of the vehicle. Specifically, the brake sensor 7 detects the amount of a pedaling operation on the brake pedal 5 as a stroke amount and outputs the detection signal corresponding to the detected amount of the pedaling operation (the stroke amount) to the first ECU 26 described later. The pedaling operation on the brake pedal 5 is transmitted to a master cylinder 8 via an electric booster 16 described later. The operation-amount detection unit is not limited to the stroke sensor which detects the amount of pedaling operation on the brake pedal 5 as the stroke amount and may also be a pedaling-force sensor for detecting a pedaling force on the brake pedal 5. Moreover, although the brake sensor 7 is provided to the brake pedal 5 as the stroke sensor, a stroke sensor which detects a stroke of an input piston 19 described later may be used instead.

The master cylinder 8 includes a cylinder main body 9 having a cylindrical shape with a closed end. Specifically, the cylinder main body 9 has an open end on one side and a bottom portion on the other side. The open-end side of the cylinder main body 9 is removably firmly fixed to a booster housing 17 of the electric booster 16 described later by using a plurality of mounting bolts (not shown) or the like. The master cylinder 8 includes the cylinder main body 9, a first piston (including a booster piston 18 and an input piston 19 described later), a second piston 10, a first hydraulic chamber 11A, a second hydraulic chamber 11B, a first return spring 12, and a second return spring 13.

Here, in the master cylinder %, the first piston includes the booster piston 18 and the input piston 19 described below. The first hydraulic chamber 11A formed inside the cylinder main body 9 is defined between the second piston 10 and the booster piston 18 (and the input piston 19). The second hydraulic chamber 11B is defined inside the cylinder main body 9 between the bottom portion of the cylinder main body 9 and the second piston 10.

The first return spring 12 is located in the first hydraulic chamber 11A, and is provided between the booster piston 18 and the second piston 10 to bias the booster piston 18 toward the open-end side of the cylinder main body 9. The second return spring 13 is located in the second hydraulic chamber 11B, and is provided between the bottom portion of the cylinder main body 9 and the second piston 10 to bias the second piston 10 toward the first hydraulic chamber 11A.

When the booster piston 18 (input piston 19) and the second piston 10 are displaced toward the bottom portion of the cylinder main body 9 in accordance with the pedaling operation of the brake pedal 5, the cylinder main body 9 of the master cylinder 8 generates a hydraulic pressure as a master-cylinder pressure by a hydraulic fluid (hereinafter referred to as brake fluid) in the first hydraulic chamber 11A and the second hydraulic chamber 11B. On the other hand, in the case where the operation of the brake pedal 5 is released, when the booster piston 18 (and the input piston 19) and the second piston 10 are displaced by the first return spring 12 and the second return spring 13 toward the opening portion of the cylinder main body 9 in a direction indicated by the arrow B, the cylinder main body 9 of the master cylinder 8 releases the hydraulic pressure in the first hydraulic chamber 11A and the second hydraulic chamber 11B while being supplied with the brake fluid from a reservoir 14 (described below).

The reservoir 14 which stores the brake fluid therein is provided as a hydraulic fluid tank to the cylinder main body 9 of the master cylinder 8. The reservoir 14 supplies the brake fluid to the hydraulic chambers 11A and 11B inside the cylinder main body 9. The hydraulic pressure as the master-cylinder pressure generated in the first hydraulic chamber 11A and the second hydraulic chamber 11B of the master cylinder 8 is transmitted to an ESC 30 described later, which is a hydraulic-pressure supply device (that is, a hydraulic-pressure control unit), through, for example, a pair of cylinder-side hydraulic pipes 15A and 15B.

The electric booster 16 is provided as a booster mechanism for increasing an operation force on the brake pedal 5 between the brake pedal 5 of the vehicle and the master cylinder 8. The electric booster 16 actuates the master cylinder 8 by an electric actuator 20 described later in accordance with the brake operation amount to supply a hydraulic pressure to the wheel cylinders 3L, 3P, 4L, and 4R. Specifically, the electric booster 16 controls the drive of the electric actuator 20 based on an output signal (a detected signal) from the brake sensor 7 to control the hydraulic pressure generated in the master cylinder 8 (that is, the master-cylinder pressure).

The electric booster 16 includes the booster housing 17, the booster piston 18, and the electric actuator 20 described later. The booster housing 17 is provided so as to be fixed to a front wall of a vehicle interior (not shown), which is the front board of the vehicle body. The booster piston 18 is provided as a driving piston to the booster housing 17 so as to be movable (that is, movable forward and backward in an axial direction of the master cylinder 8). The electric actuator 20 applies a booster thrust to the booster piston 18.

The booster piston 18 is formed of a cylindrical member which is slidably inserted and fitted into the cylinder main body 9 of the master cylinder 8 from the open-end side in the axial direction. On the inner circumferential side of the booster piston 18, the input piston 19 is slidably inserted and fitted. The input piston 19 is formed of a shaft member which is directly pressed in accordance with the operation of the brake pedal 5 to move forward and backward in the axial direction of the master cylinder 8 (that is, in directions indicated by the arrows A and B). The input piston 19 serves as the first piston of the master cylinder 8 together with the booster piston 18. Inside the cylinder main body 9, the first hydraulic chamber 11A is defined between the second piston 10, and the booster piston 18 and the input piston 19.

The booster housing 17 includes a speed-reducer case 17A having a cylindrical shape, a support case 17B having a cylindrical shape, and a lid body 17C having a cylindrical shape with a step. The speed-reducer case 17A houses a speed-reduction mechanism 23 described later therein. The support case 17B is provided between the speed-reducer case 17A and the cylinder main body 9 of the master cylinder 8, and supports the booster piston 18 so that the booster piston 18 is slidably displaceable in the axial direction. The lid body 17C is provided on the side opposite to the support case 17B in the axial direction (one axial side) across the speed-reducer case 17A, and closes an opening of the speed-reducer case 17A on one axial side. On the outer circumferential side of the speed-reducer case 17A, a support plate 17 for fixedly supporting a drive motor 21 described later is provided.

The input piston 19 as an input member is inserted from the lid body 17C side into the booster housing 17, and extends inside the booster piston 18 in the axial direction toward the first hydraulic chamber 11A. An end surface of the input piston 19 on a distal end side (the other axial side) receives the hydraulic pressure generated in the first hydraulic chamber 11A at the time of the brake operation as a brake reaction force (hydraulic reaction force). The input piston 19 transmits the generated hydraulic pressure to the brake pedal 5. As a result, an appropriate pedal feeling is provided to the driver of the vehicle through the brake pedal 5. Thus, a good pedal feeling (good braking) can be obtained. As a result, an operation feeling for the brake pedal 5 can be improved and a good pedal feeling (firm pedal feeling) can thus be maintained. As described above, in this embodiment, the input piston 19 forms a transmission unit which transmits the hydraulic reaction force generated in accordance with the hydraulic pressure in the master cylinder 8 to the brake pedal 5. The input piston 19 is included in the electric booster 16, and has the end surface on the distal end side (the other axial side) which is exposed in the first hydraulic chamber 11A of the master cylinder 8. The transmission unit is not limited to the input piston 19. The hydraulic pressure in the master cylinder 8 may be supplied to a hydraulic cylinder which is provided independently of the electric booster 16. Beside the mechanism which directly transmits the hydraulic pressure of the master cylinder 8, the transmission unit may also have a mechanism which applies the reaction force to the brake pedal 5 by the electric actuator 20 that is actuated based on a signal from a hydraulic-pressure sensor 30 described later, that is, transmits the hydraulic reaction force indirectly to the brake pedal 5.

The electric actuator 20 of the electric booster 16 includes the drive motor 21, the speed-reduction mechanism 23 such as a belt, and a linear-motion mechanism 24 such as a ball screw. The drive motor 21 including an electric motor is provided to the speed-reducer case 17A of the booster housing 17 through intermediation of the support plate 17D. The speed-reduction mechanism 23 transmits the rotation of the drive motor 21 to a cylindrical rotary body 22 provided in the speed-reducer case 17A after reducing the speed of the rotation. The linear-motion mechanism 24 converts the rotation of the cylindrical rotary body 22 into an axial displacement (forward and backward movement) of the booster piston 18. The booster piston 18 and the input piston 19 each have a front end (the other axial end) exposed in the first hydraulic chamber 11A of the master cylinder 8, and generates the brake fluid pressure in the master cylinder 8 by the pedaling force (thrust) transmitted from the brake pedal 5 to the input piston 19 and the booster thrust transmitted from the electric actuator 20 to the booster piston 18.

Specifically, the booster piston 18 of the electric booster 16 forms a pump mechanism which is driven by the electric actuator 20 based on the output (power feeding) from the first ECU 26 described later to generate the brake fluid pressure (master-cylinder pressure) in the master cylinder 8. A return spring 25 for constantly biasing the booster piston 18 in a direction in which the braking is released (direction indicated by the arrow B illustrated in FIG. 1) is provided inside the support case 17B of the booster housing 17. When the drive motor 21 is rotated in a reverse direction at the time of release of the brake operation, the booster piston 18 is returned in the direction indicated by the arrow B to an initial position illustrated in FIG. 1 and is also returned in the direction indicated by the arrow B by a biasing force of the return spring 25.

The drive motor 21 is formed by using, for example, a DC brushless motor. A rotation sensor 21A called “resolver” is provided to the drive motor 21. The rotation sensor 21A detects a position of rotation of the drive motor 21 (motor shaft), and outputs the detection signal to the first ECU 26 described later. The rotation sensor 21A also has a function as a rotation detection unit to detect a rotational displacement of the drive motor 21 to detect an absolute displacement of the booster piston 18 with respect to the vehicle body based on the detected rotational displacement.

Further, together with the brake sensor 7, the rotation sensor 21A constitutes a displacement detection unit for detecting a relative displacement amount between the booster piston 18 and the input piston 19. The detection signals of the rotation sensor 21A and the brake sensor 7 are transmitted to the first ECU 26. The rotation detection unit is not limited to the rotation sensor 21A such as the resolver, but may also be a rotary potentiometer capable of detecting the absolute displacement (angle). The speed-reduction mechanism 23 is not limited to the belt or the like, and may also be formed by using, for example, a gear speed-reduction mechanism or the like. Further, the speed-reduction mechanism 23 may not be provided, and the cylindrical rotary body 22 may be directly rotated by the drive motor 21.

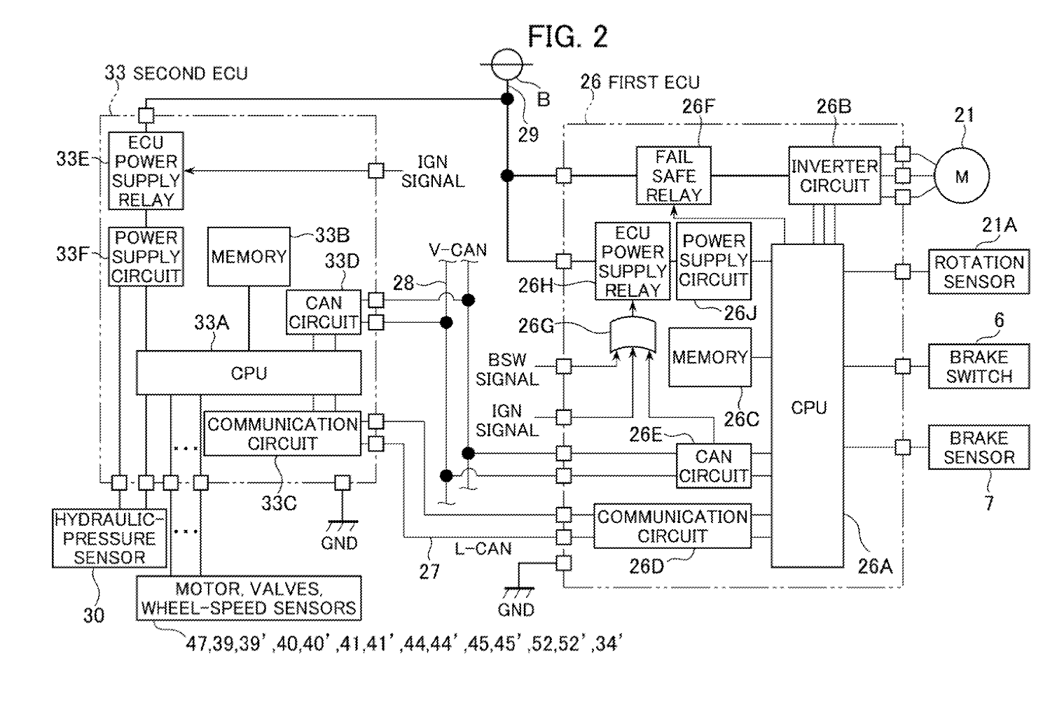

The first ECU 26 as a master-cylinder pressure control unit includes a microcomputer (CPU) 26A and a plurality of electronic circuits, as illustrated in FIG. 2. The first ECU 26 is a controller (control device) for the electric booster, which electrically controls the drive of the electric actuator 20 of the electric booster 16. Specifically, as the master-cylinder pressure control unit, the first ECU 26 controls the drive motor 21 for pressurizing the hydraulic fluid in the master cylinder 8 by the operation of the brake pedal 5 to which the hydraulic reaction force is transmitted and thrusts the piston (booster piston 18) of the master cylinder 8 by a rotating force of the drive motor 21.

In this case, the first ECU 26 includes an inverter circuit 26B to be controlled by the CPU 26A. By current supply from the inverter circuit 26B, the drive motor 21 is controlled. The first ECU 26 also includes a memory 26C. In the memory 26C, a processing program for determining whether or not boost control is required and data for the control are stored.

The brake switch 6, the brake sensor 7, and the rotation sensor 21A of the drive motor 21 are connected to the CPU 26A of the first ECU 26. The brake switch 6 detects whether or not the brake pedal 5 is operated through an interface circuit (not shown). The brake sensor 7 detects the brake operation amount (the pedaling operation amount of or the pedaling force on the brake pedal 5). Moreover, an in-vehicle communication line 27 called L-CAN, for example, through which communication can be performed, is connected to the CPU 26A through a communication circuit 26D. The CPU 26A is also connected to a vehicle data bus 28 through a CAN circuit 26E. The vehicle data bus 28 is a serial communication network called V-CAN mounted in the vehicle.

The first ECU 26 is supplied with power from an in-vehicle battery B through a power supply line 29. As illustrated in FIG. 2, the power from the power supply line 29 is supplied to the inverter circuit 26B through a fail safe relay 26F which is subjected to OFF control by the CPU 26A. The power from the power supply line 29 is supplied to a power supply circuit 26J through an ECU power supply relay 26H. The ECU power supply relay 26H is subjected to ON/OFF control by an activation determination circuit 26G which is an OR circuit. The power supply circuit 26J converts a power supply voltage into a voltage for activating the CPU 26A (for example, converts a 12V vehicle power supply to 5V). From the power supply circuit 26J, the power is fed to the CPU 26A, circuits, and sensors.

When the ECU power supply relay 26H is brought into an energized state to start the energization of the CPU 26A, the system of the first ECU 26 is activated (started). An ignition-ON signal (IGN signal) from an ignition switch, the ON signal of the brake lamp switch signal (BSW signal) from the brake switch 6, and a wakeup signal from the CAN circuit 26E are input to the activation determination circuit 26G which controls the energization of the ECU power supply relay 26H. By receiving input of any one of the signals described above, the activation determination circuit 26G controls the ECU power supply relay 26H so as to be brought into the energized state.

Here, the ignition-ON signal is transmitted as a start signal for the vehicle (enables energization) through the signal line when the vehicle is to be activated (started or powered ON). Specifically, when, for example, the driver operates a start button device or a start key device (both not shown) provided in the vicinity of the driver's seat so as to activate the vehicle, the ignition-ON signal is transmitted to the first ECU 26 and a second ECU 33 described later from the start button device or the start key device described above. As described later, the ignition-ON signal (IGN signal) is a start signal for activating (starting) the vehicle, that is, “one start signal” for activating the system of the first ECU 26 and the system of the second ECU 33.

On the other hand, the ON signal (BSW signal) of the brake lamp signal is “another start signal” for activating (starting) the system of the first ECU 26. In this case, the system of the first ECU 26 is activated (started) in accordance with the ignition-ON signal for the vehicle as the “one start signal” input through the signal line or the brake lamp switch signal (brake-ON signal) as the “another start signal” input from the brake switch 6 which detects the depression of the brake pedal 5.

The hydraulic-pressure sensor 30 as a pressure detection unit detects the hydraulic pressure generated in the master cylinder 8. Specifically, the hydraulic-pressure sensor 30 detects a hydraulic pressure in, for example, the cylinder-side hydraulic pipe 15A and therefore detects a brake fluid pressure supplied from the master cylinder 8 through the cylinder-side hydraulic pipe 15A to an ESC 31 (hydraulic-pressure control unit) described later. The hydraulic-pressure sensor 30 is supplied with the power from the second ECU 33 described later and is electrically connected to the second ECU 33 so that a detection signal of the hydraulic pressure is output to the second ECU 33. The detection signal of the hydraulic pressure detected by the hydraulic-pressure sensor 30 is transmitted from the second ECU 33 through the communication line 27 to the first ECU 26 by the communication.

The first ECU 26 is connected to the drive motor 21, the in-vehicle communication line 27, and the vehicle data bus 28. Then, the first ECU 26 controls the electric actuator 20 (the rotation of the drive motor 21) so as to generate the hydraulic pressure in the master cylinder 8 based on the detection signal from the brake sensor 7 (detection value of the operation of the brake). Specifically, the first ECU 26 variably controls the brake fluid pressure to be generated in the master cylinder 8 by the electric booster 16 in accordance with the detection signals from the brake sensor 7 and the hydraulic-pressure sensor 30, and also determines whether or not the electric booster 16 is operating normally.

Here, in the electric booster 16, when the brake pedal 5 is operated, the input piston 19 moves forward toward the cylinder main body 9 of the master cylinder 8 and the movement of the input piston 19 is detected by the brake sensor 7. In response to the detection signal from the brake sensor 7, the first ECU 26 feeds power to the drive motor 21 to rotationally drive the drive motor 21. The rotation of the drive motor 21 is transmitted to the cylindrical rotary body 22 through an intermediation of the speed-reduction mechanism 23. Then, the rotation of the cylindrical rotary body 22 is converted into the axial displacement of the booster piston 18 by the linear-motion mechanism 24.

In this manner, the booster piston 18 displaces in the forward direction into the cylinder main body 9 of the master cylinder 8. As a result, the brake fluid pressure in accordance with the pedaling force (thrust) applied to the input piston 19 from the brake pedal 5 and a booster thrust applied to the booster piston 18 from the electric actuator 20 is generated in the first hydraulic chamber 11A and the second hydraulic chamber 11B in the master cylinder 8. By receiving the detection signal from the hydraulic-pressure sensor 30 via the signal line 27, the first ECU 26 can monitor the hydraulic pressure generated in the master cylinder 8, and therefore can determine whether or not the electric booster 16 is operating normally.

The hydraulic-pressure supply device 31 (also referred to as “ESC 31”) as the hydraulic-pressure control unit, which is provided between the wheel cylinders 3L, 3R, 4L, and 4R provided on the respective wheels (front wheels 1L and 1R and rear wheels 2L and 2R) of the vehicle, and the master cylinder 8 is now described.

The ESC 31 as the hydraulic-pressure control unit is provided between the master cylinder 8 and the wheel cylinders 3L, 3R, 4L, and 4R, and supplies and stops the brake fluid to the wheel cylinders 3L, 3R, 4L, and 4R. Specifically, the ESC 31 supplies the hydraulic pressure generated in the master cylinder 8 (the first hydraulic chamber 11A and the second hydraulic chamber 11B) as the master-cylinder pressure by the electric booster 16 individually to the wheel cylinders 3L, 3R, 4L, and 4R for the respective wheels.

More specifically, the ESC 31 constitutes a brake assist apparatus. When the brake fluid pressure to be supplied from the master cylinder 8 through the cylinder-side hydraulic pipes 15A and 15B to the wheel cylinders 3L, 3R, 4L, and 4R is insufficient or various types of brake control (for example, braking-force distribution control for distributing a braking force to the front wheels 1L and 1R and the rear wheels 2L and 2R, anti-lock brake control, vehicle stabilization control, and the like) are performed, the ESC 31 supplies a necessary brake fluid pressure obtained by compensation to the wheel cylinders 3L, 3R, 4L, and 4R.

The ESC 31 distributes and supplies the hydraulic pressure output from the master cylinder 8 (first hydraulic chamber 11A and second hydraulic chamber 11B) through the cylinder-side hydraulic pipes 15A and 15B to the wheels cylinders 3L, 3R, 4L, and 4R through brake-side pipe portions 32A, 32B, 32C, and 32D. In this manner, for the front wheels 1L and 1R and the rear wheels 2L and 2R, the independent braking force is applied to each of the wheels as described above. The ESC 31 includes control valves 39, 39′, 40, 40′, 41, 41′, 44, 44′, 45, 45′, 52, and 52′, and an electric motor 47 for driving hydraulic pumps 46 and 46′.

A wheel-cylinder fluid supply control unit includes the ESC 31 and the second ECU 33. The ESC 31 is provided between the master cylinder 8 and the wheel cylinders 3L, 3R, 4L, and 4R and is the hydraulic-pressure control unit for controlling the communication and interruption of fluid paths by electromagnetic valves (that is, controls valves 39, 39′, 40, 40′, 41, 41′, 44, 44′, 45, 45′, 52, and 52′). The second ECU 33 is a controller for the ESC 31.

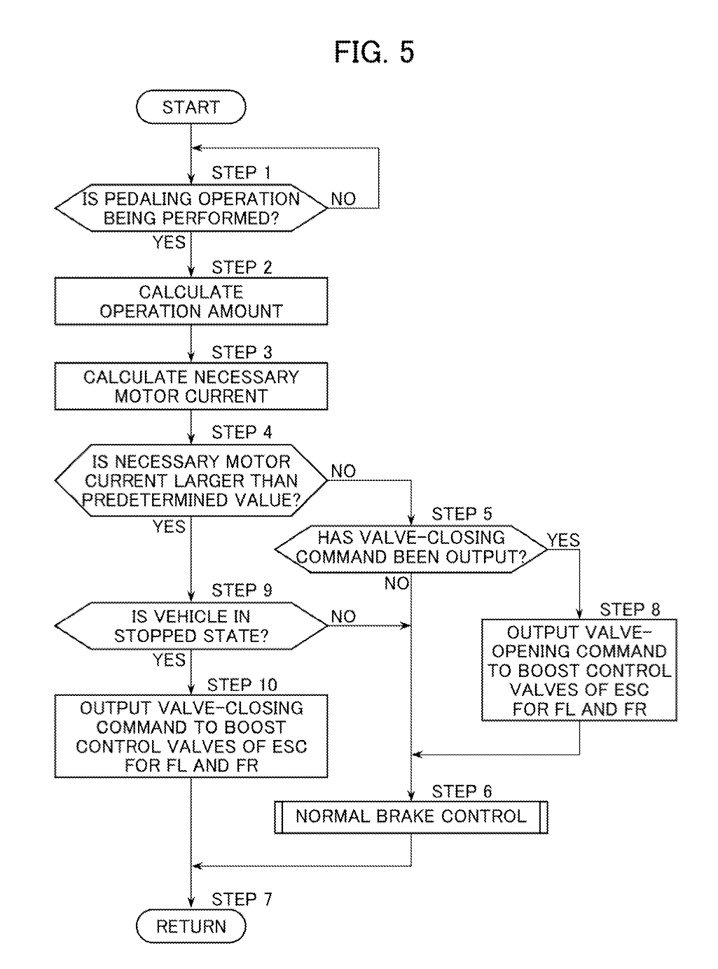

The second ECU 33 as the wheel-cylinder fluid supply control unit controls the actuation of the ESC 31 as the hydraulic-pressure control unit. Specifically, similarly to the first ECU 26, the second ECU 33 is the controller (control device) for the hydraulic-pressure supply device, for electrically controlling the drive of the ESC 31. The second ECU 33 includes a microcomputer (CPU) 33A and a plurality of electronic circuits as illustrated in FIG. 2. In this case, the second ECU 33 includes a memory 33B. In the memory 33B, a control processing program is stored, which is used for performing control for supplying and control for stopping the brake fluid to the wheel cylinders 3L, 3R, 4L, and 4R described later, which are illustrated in FIG. 5.

The hydraulic-pressure sensor 30, wheel-speed sensors 34 described later, the control valves 39, 39′, 40, 40′, 41, 41′, 44, 44′, 45, 45′, 52, and 52′, and the electric motor 47 are connected to the CPU 33A of the second ECU 33 through an intermediation of an interface circuit (not shown). The communication line 27 (L-CAN) is connected through a communication circuit 33C to the CPU 33A of the second ECU 33, while the vehicle data bus 28 (V-CAN) is connected through a CAN circuit 33D thereto.

The second ECU 33 is connected to the power supply line 29 and fed with the power from the battery B through the power supply line 29. More specifically, as illustrated in FIG. 2, the power from the power supply line 29 is supplied to a power supply circuit 33F for converting the power supply voltage to a voltage for actuating the CPU 33A (for example, a 12V vehicle power supply to 5V) through an ECU power supply relay 33E. Then, the power is fed from the power supply circuit 33F to the CPU 33A, the circuits, the hydraulic-pressure sensor 30, and other sensors. When the ECU power supply relay 33E is brought into the energized state to start the energization of the CPU 33A, the system of the second ECU 33 is activated (started). The ignition-ON signal (IGN signal) is input from the ignition switch to the ECU power supply relay 33E. By receiving the input (energization) of the ignition-ON signal (IGN signal), the ECU power supply relay 33E is placed in the energized state.

Here, the ignition-ON signal is transmitted as the start signal for the vehicle (enables energization) through the signal line when the vehicle is to be activated (started or powered ON). Specifically, when, for example, the driver operates the start button device or the start key device (both not shown) in the vicinity of the driver's seat so as to activate the vehicle, the ignition-ON signal is transmitted to (enables energization of) the first ECU 26 and the second ECU 33 from the start button device or the start key device described above. In this case, the ignition-ON signal (IGN signal) corresponds to the start signal for activating (starting) the vehicle, that is, the “one start signal” for activating the system of the first ECU 26 and the system of the second ECU 33.

Further, the wheel-speed sensors 34 (four sensors in total in FIG. 1) for individually detecting rotation speeds (wheel speeds) of the front wheels 1L and 1R and the rear wheels 2L and 2R are connected to the second ECU 33. The second ECU 33 performs necessary control such as anti-lock brake control for preventing each of the front wheels 1L and 1R and the rear wheels 2L and 2R from being locked in accordance with detection values (detection signals) from the respective wheel-speed sensors 34.

In the first embodiment, the hydraulic-pressure sensor 30 as the pressure detection unit is connected to the second ECU 33, as illustrated in FIG. 1. However, the configuration of this embodiment is not limited thereto. The brake sensor 7 as the operation-amount detection unit may alternatively be connected to the second ECU 33, as indicated by the dotted line L in FIG. 1. In this case, the brake sensor 7 can be connected to the second ECU 33 directly or through a controller (not shown) different from the first ECU 26. In any of the cases, the hydraulic-pressure sensor 30 as the pressure detection unit and the brake sensor 7 as the operation-amount detection unit are connected to the second ECU 33.

The second ECU 33 individually controls the drive of the control valves 39, 39′, 40, 40′, 41, 41′, 44, 44′, 45, 45′, 52, and 52′ and the electric motor 47 of the ESC 31 as described later. In this manner, the second ECU 33 performs control of reducing, maintaining, boosting, or pressurizing the brake fluid pressures to be supplied from the brake-side pipe portions 32A to 32D to the wheel cylinders 3L, 3R, 4L, and 4R individually for the wheel cylinders 3L, 3R, 4L, and 4R.

Specifically, by controlling the actuation of the ESC 31, the second ECU 33 can perform, for example, control (1) to (8) described below. More specifically, the second ECU 33 can perform (1) braking-force distribution control for appropriately distributing a braking force to the respective wheels (1L, 1R, 2L, and 2R) in accordance with a vertical load at the wheel when the vehicle is to be braked; (2) anti-lock brake control for automatically adjusting the braking force to be applied to each of the wheels (1L, 1R, 2L, and 2R) at the time of braking to prevent the front wheels 1L and 1R and the rear wheels 2L and 2R from being locked; (3) vehicle stabilization control for suppressing understeering and oversteering while detecting a skid of each of the wheels (1L, 1R, 2L, and 2R) during running to automatically control appropriately the braking force to be applied to each of the wheels (1L, 1R, 2L, and 2F) regardless of the operation amount of the brake pedal 5 so as to stabilize a behavior of the vehicle; (4) hill start aid control for retaining a braked state on a hill (in particular, an uphill) to assist the vehicle in starting; (5) traction control for preventing each of the wheels (1L, 1R, 2L, and 2R) from idling at the start of the vehicle or the like; (6) vehicle tracking control for maintaining a certain distance from a vehicle in front; (7) lane departure avoiding control for keeping the vehicle in a driving lane; and (8) obstacle avoidance control for avoiding a collision against an obstacle in front of or behind the vehicle.

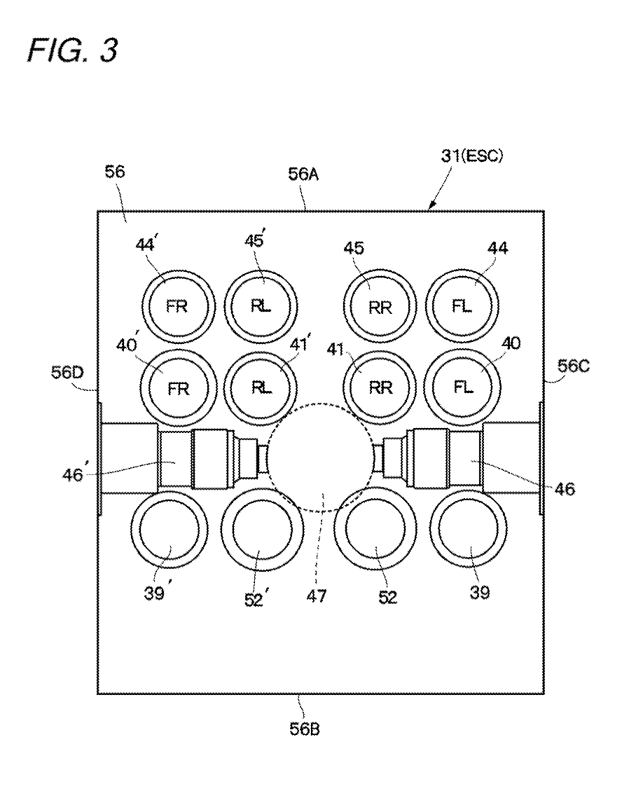

The ESC 31 as the hydraulic-pressure control unit includes a housing 56 described below (FIG. 3) which forms an outer shell therefor. In the housing 56, a dual-system hydraulic circuit including a first hydraulic system 35 and a second hydraulic system 35′ is provided. The first hydraulic system 35 is connected to one (that is, the cylinder-side hydraulic pipe 15A) of output ports of the master cylinder 8 to supply the hydraulic pressure to the wheel cylinder 3L for the left front wheel (FL) and the wheel cylinder 4R for the right rear wheel (RR). The second hydraulic system 35′ is connected to another (that is, the cylinder-side hydraulic pipe 15B) of the output ports to supply the hydraulic pressure to the wheel cylinder 3R for the right front wheel (FR) and the wheel cylinder 4L for the left rear wheel (RL).

Here, the first hydraulic system 35 and the second hydraulic system 35′ have the same configuration. Therefore, only the first hydraulic system 35 is described below. For the second hydraulic system 35′, the reference symbols of the respective components are followed by the apostrophe “′”, and the description thereof is herein omitted.

The first hydraulic system 35 of the ESC 31 includes a brake pipeline 36 connected to a distal end of the cylinder-side hydraulic pipe 15A. The brake pipeline 36 branches into a first pipeline portion 37 and a second pipeline portion 38, which are respectively connected to the wheel cylinders 3L and 4R. The brake pipeline 36 and the first pipeline portion 37 constitute a pipeline for supplying the hydraulic pressure to the wheel cylinder 3L together with the brake-side pipeline portion 32A, whereas the brake pipeline 36 and the second pipeline portion 38 constitute a pipeline for supplying the hydraulic pressure to the wheel cylinder 4R together with the brake-side pipeline portion 32D.

The brake fluid-pressure supply control valve 39 (hereinafter referred to simply as “supply control valve 39”) is provided to the brake pipeline 36 so as to be parallel to a check valve 53 described later. The supply control valve 39 is a normally-open electromagnetic selector valve for opening and closing the brake pipeline 36. A boost control, valve 40 is provided to the first pipeline portion 37. The boost control valve 40 is a normally-open electromagnetic selector valve for opening and closing the first pipeline portion 37. A boost control valve 41 is provided to the second pipeline portion 38. The boost control valve 41 is a normally-open electromagnetic valve for opening and closing the second pipeline portion 38 as well.

On the other hand, the first hydraulic system 35 of the ESC 31 includes a first pressure-reduction pipeline 42 for connecting the wheel cylinder 3L side and a reservoir 51 for hydraulic-pressure control and a second pressure-reduction pipeline 43 for connecting the wheel cylinder 4R side and the reservoir 51. A first pressure-reduction control valve 44 is provided to the first pressure-reduction pipeline 42, whereas a second pressure-reduction control valve 45 is provided to the second pressure-reduction pipeline 43. The first pressure-reduction control valve 44 is a normally-closed electromagnetic selector valve for opening and closing the first pressure-reduction pipeline 42. Similarly, the second pressure-reduction control valve 45 is a normally-closed electromagnetic selector valve for opening and closing the second pressure-reduction pipeline 43.

The ESC 31 includes the hydraulic pump 46 including a plunger pump as a hydraulic-pressure generation unit which is a hydraulic-pressure source. The hydraulic pump 46 is rotationally driven by the electric motor 47. The electric motor 47 is driven by power fed from the second ECU 33. When the power feeding is stopped, the rotation of the electric motor 47 is stopped with the stop of the rotation of the hydraulic pump 46. A discharge side of the hydraulic pump 46 is connected to a portion of the brake pipeline 36, which is located on the downstream side of the supply control valve 39 (that is, at a position at which the first pipeline portion 37 and the second pipeline portion 38 branch) through a check valve 48. An intake side of the hydraulic pump 46 is connected to the reservoir 51 for hydraulic-pressure control through check valves 49 and 50.

The reservoir 51 for hydraulic-pressure control is provided to temporarily store an excessive brake fluid. The reservoir 51 for hydraulic-pressure control temporarily stores the excessive brake fluid flowing out from cylinder chambers (not shown) of the wheel cylinders 3L and 4R not only at the time of ABS control for the brake system (ESC 31) but also at the time of other brake control. The intake side of the hydraulic pump 46 is connected to the cylinder-side hydraulic pipe 15A of the master cylinder 8 (that is, to a portion of the brake pipeline 36, which is located on the upstream side of the supply control valve 39) through the check valve 49 and a pressurization control valve 52 which is a normally-closed electromagnetic selector valve.

The check valve 53 is provided in the middle of the brake pipeline 36 so as to be parallel to the supply control valve 39. The check valve 53 allows the brake fluid to flow from the master cylinder 8 side into the brake pipeline 36 and inhibits a flow in the opposite direction. A check valve 54 is provided to the first pipeline portion 37 so as to be parallel to the boost control valve 40. The check valve 54 allows the brake fluid to flow from the wheel cylinder 3L side into the first pipeline portion 37 and inhibits a flow in the opposite direction. Further, a check valve 55 is provided to the second pipeline portion 38 so as to be parallel to the boost control valve 41. The check valve 55 allows the brake fluid to flow from the wheel cylinder 4R side into the second pipeline portion 38 and inhibits a flow in the opposite direction.

For each of the control valves 39, 39′, 40, 40′, 41, 41′, 44, 44′, 45, 45′, 52, and 52′ and the electric motor 47 (motor for driving the hydraulic pumps 46 and 46′) that constitute the ESC 31, operation control is performed in a predetermined procedure in accordance with power fed from the second ECU 33.

Specifically, the first hydraulic system 35 of the ESC 31 directly supplies the hydraulic pressure generated in the master cylinder 8 by the electric booster 16 to the wheel cylinders 3L and 4R through the brake pipeline 36, the first pipeline portion 37, and the second pipeline portion 38 at the time of a normal operation based on the brake operation performed by the driver. For example, when antiskid control is to be executed, the boost control valves 40 and 41 are closed to maintain the hydraulic pressure in the wheel cylinders 3L and 4R. When the hydraulic pressure in the wheel cylinders 3L and 4R is to be reduced, the pressure-reduction control valves 44 and 45 are opened so that the hydraulic pressure in the wheel cylinders 3L and 4R is exhausted to be released to the reservoir 51 for hydraulic-pressure control.

When the hydraulic pressure to be supplied to the wheel cylinders 3L and 4R is to be boosted for stabilization control (antiskid control) during running of the vehicle, the hydraulic pump 46 is actuated by the electric motor 47 in a state in which the supply control valve 39 is closed. In this manner, the brake fluid discharged from the hydraulic pump 46 is supplied to the wheel cylinders 3L and 4R through the first pipeline portion 37 and the second pipeline portion 38, respectively. At this time, the pressurization control valve 52 is opened. As a result, the brake fluid stored in the reservoir 14 is supplied from the master cylinder 8 side to the intake side of the hydraulic pump 46.

As described above, the second ECU 33 controls the actuation of the supply control valve 39, the boost control valves 40 and 41, the pressure-reduction control valves 44 and 45, the pressurization control valve 52, and the electric motor 47 (that is, the hydraulic pump 46) based on vehicle operation information so as to appropriately maintain, reduce, or boost the hydraulic pressure to be supplied to the wheel cylinders 3L and 4R. As a result, the above-mentioned brake control such as the braking-force distribution control, the vehicle stabilization control, the brake assist control, the antiskid control, the traction control, and the hill start aid control is executed.

On the other hand, in a normal braking mode which is executed in a state in which the electric motor 47 (that is, the hydraulic pump 46) is stopped, the supply control valve 39 and the boost control valves 40 and 41 are opened, whereas the pressure-reduction valves 44 and 45 and the pressurization control valve 52 are closed. In this state, when the first piston (that is, the booster piston 18 and the input piston 19) and the second piston 10 of the master cylinder 8 displace in the axial direction inside the cylinder main body 9 in accordance with the pedaling operation of the brake pedal 5, the brake fluid pressure generated in the first hydraulic chamber 11A is supplied from the cylinder-side hydraulic pipe 15A side through the first hydraulic system 35 and the brake-side pipe portions 32A and 32D of the ESC 31 to the wheel cylinders 3L and 4R. The brake fluid pressure generated in the second hydraulic chamber 11B is supplied from the cylinder-side hydraulic pipe 15B side through the second hydraulic system 35′ and the brake-side pipe portions 32B and 32C to the wheel cylinders 3R and 4L.

In a brake assist mode which is executed when the brake fluid pressure generated in the first hydraulic chamber 11A and the second hydraulic chamber 11B (that is, the hydraulic pressure in the cylinder-side hydraulic pipe 15A, which is detected by the hydraulic-pressure sensor 30) is insufficient, the pressurization control valve 52 and the boost control valves 40 and 41 are opened, while the supply control valve 39 and the pressure-reduction control valves 44 and 45 are appropriately opened and closed. In this state, the hydraulic pump 46 is actuated by the electric motor 47 so that the brake fluid discharged from the hydraulic pump 46 is supplied to the wheel cylinders 3L and 4R through the first pipeline portion 37 and the second pipeline portion 38, respectively, in this manner, together with the brake fluid pressure generated on the master cylinder 8 side, the braking force by the wheel cylinders 3L and 4R can be generated by the brake fluid discharged from the hydraulic pump 46.

Further, in the case of failure of the electric booster 16, the hydraulic pump 46 can be actuated by the electric motor 47 based on the detection signal from the hydraulic-pressure sensor 30 (or the detection signal from the brake sensor 7 when the brake sensor 7 is connected to the second ECU 33), which changes in accordance with the operation of the brake by the driver. By the brake fluid discharged from the hydraulic pumps 46 and 46′, the wheel cylinders 3L, 3R, 4L, and 4R can be pressurized (hereinafter described as “wheel cylinders are boosted” for the purpose of illustration).

A known hydraulic pump, such as a plunger pump, a trochoid pump, and a gear pump can be used as the hydraulic pump 46. In the first embodiment, the plunger pump is used as illustrated in FIG. 3, for example. A known motor, such as a DC motor, a DC brushless motor, and an AC motor can be used as the electric motor 47. In this embodiment, the DC motor is used in view of adaptability to vehicle installation.

Characteristics of the control valves 39, 40, 41, 44, 45, and 52 of the ESC 31 can be appropriately set in accordance with a mode of use of each of the control valves. Among the above-mentioned control valves, the supply control valve 39 and the boost control valves 40 and 41 are configured as the normally-open valves, whereas the pressure-reduction control valves 44 and 45 and the pressurization control valve 52 are configured as the normally-closed valves. As a result, even when no power is fed from the second ECU 33, the hydraulic pressure can be supplied from the master cylinder 8 to the wheel cylinders 3L, 3R, 4L, and 4R. Therefore, in view of fail safe and control efficiency of the brake apparatus, the use of the above-mentioned configuration is desired.

As illustrated in FIG. 3, the housing 56, which forms the outer shell for the hydraulic-pressure control unit (ESC 31), is formed to have a cuboidal block structure by a molding unit such as aluminum die casting. The housing 56 includes an upper side surface 56A, a lower side surface 56B, a right side surface 56C, and a left side surface 56D. In order to reduce the housing 56 in size, the electromagnetic valves (that is, the control valves 39, 39′, 40, 40′, 41, 41′, 44, 44′, 45, 45′, 52, and 52′) are arranged in a distributed manner with the hydraulic pumps 46 and 46′ which are plunger pumps being provided thereamong.

Specifically, in the housing 56, the boost control valves 40, 40′, 41, and 41′ and the pressure-reduction control valves 44, 44′, 45, and 45′ are provided above the plunger pumps (hydraulic pumps 46 and 46′), whereas the supply control valves 39 and 39′ and the pressurization control valves 52 and 52′ are provided below the hydraulic pumps 46 and 46′. The boost control valve 40, which is connected to the wheel cylinder 3L for the front wheel 1L through the brake-side pipe portion 32A, is provided at a position close to the side surface 56C which is an outer side surface of the housing 56. Similarly, the boost control valve 40′, which is connected to the wheel cylinder 3P for the front wheel 1R through the brake-side pipe portion 32B, is provided at a position close to the side surface 56D which is an outer side surface of the housing 56.

On the other hand, as illustrated in FIG. 1, a regenerative cooperation control device 57 for power charge is connected to the vehicle data bus 28 mounted in the vehicle. The regenerative cooperation control device 57 is a microcomputer or the like as in the case of the first ECU 26 and the second ECU 33. The regenerative cooperation control device 57 uses an inertial force generated by the rotation of the wheels to control a drive motor (not shown) for driving the vehicle when the vehicle decelerates or is braked, thereby obtaining the braking force while recovering kinetic energy as power. The regenerative cooperation control device 57 is connected to the first ECU 26 and the second ECU 33 through the vehicle data bus 28. The regenerative cooperation control device 57 is connected to the power supply line 29 to be supplied with the power from the battery B (see FIG. 2) through the power supply line 29.

The brake apparatus including the brake control apparatus according to the first embodiment has the configuration described above. The actuation of the brake apparatus is now described.

First, when the driver of the vehicle performs the pedaling operation of the brake pedal 5, the input piston 19 is pressed in the direction indicated by the arrow A. At the same time, the detection signal from the brake sensor 7 is input to the first ECU 26. The first ECU 26 controls the actuation of the electric actuator 20 of the electric booster 16 in accordance with the detection value of the detection signal from the brake sensor 7. Specifically, the first ECU 26 feeds the power to the drive motor 21 based on the detection signal from the brake sensor 7, thereby rotationally driving the drive motor 21.

The rotation of the drive motor 21 is transmitted to the cylindrical rotary body 22 through an intermediation of the speed-reduction mechanism 23, and the rotation of the cylindrical rotary body 22 is converted into an axial displacement of the booster piston 18 by the linear-motion mechanism 24. As a result, the booster piston 18 of the electric booster 16 is displaced in the forward direction to move into the cylinder main body 9 of the master cylinder 8. As a result, the brake fluid pressure in accordance with the pedaling force (thrust) applied from the brake pedal 5 to the input piston 19 and the booster thrust applied from the electric actuator 20 to the booster piston 18 is generated in the first hydraulic chamber 11A and the second hydraulic chamber 11B of the master cylinder 8.

Next, the ESC 31, which is provided between the wheel cylinders 3L, 3R, 4L, and 4P for the respective wheels (the front wheels 1L and 1R and the rear wheels 2L and 2R) and the master cylinder 8, variably controls the hydraulic pressure from the cylinder-side hydraulic pipes 15A and 15B through the hydraulic systems 35 and 35′ and the brake-side pipe portions 32A, 32B, 32C, and 32D included in the ESC 31 to the wheel cylinders 3L, 3R, 4L, and 4R. At the same time, the ESC 31 distributes the hydraulic pressure as the master cylinder pressure generated in the master cylinder 8 (the first hydraulic chamber 11A and the second hydraulic chamber 11B) by the electric booster 16 into wheel-cylinder pressures for the respective wheels to be supplied thereto. In this manner, appropriate braking forces are individually applied to the wheels (the front wheels 1L and 1R and the rear wheels 2L and 2R) of the vehicle through the wheel cylinders 3L, 3R, 4L, and 4R.

The second ECU 33 for controlling the ESC 31 feeds the power to the electric motor 47 to actuate the hydraulic pumps 46 and 46′ so as to selectively open and close the control valves 39, 39′, 40, 40′, 41, 41′, 44, 44′, 45, 45′, 52, and 52′. In this manner, the braking-force distribution control, the anti-lock brake control, the vehicle stabilization control, the hill start aid control, the traction control, the vehicle tracking control, the lane departure avoiding control, and the obstacle avoidance control can be executed.

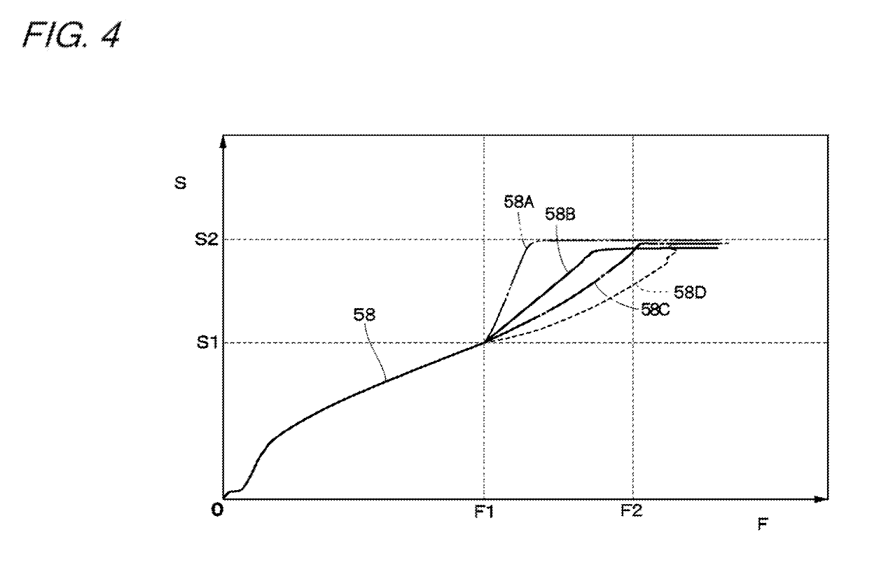

The following problem sometimes occurs in the brake apparatus including the electric booster 16. Specifically, when the driver depresses the brake pedal 5, the drive motor 21 thrusts the booster piston 18 in the direction indicated by the arrow A in FIG. 1 as a result of the forward movement of the input piston 19. Then, the hydraulic pressure in the master cylinder 8 increases at an approximately constant boost ratio in accordance with the operation amount of the brake pedal 5. In this case, the relationship between an operation amount S of the brake pedal 5 and a pedaling force F (that is, a pedal reaction force) thereon can be represented as a characteristic line 58 indicated by the solid line in FIG. 4.

When the driving force (output) of the drive motor 21 reaches a maximum driving force and hence, the thrust of the booster piston 18 and the reaction force generated by the hydraulic pressure in the master cylinder 8 are balanced with each other, the drive motor 21 comes into a full-load state to stop the booster piston 18. As a result, the booster piston 18 cannot move forward any more (in a state where the operation amount S of the brake pedal 5 becomes an operation amount S1 and the pedaling force F becomes a pedaling force F1 in FIG. 4). When the vehicle is running, the driver does not perform a large amount of the pedaling operation on the brake pedal 5 in practice to achieve a deceleration to bring about the full-load state in which the driving force of the drive motor 21 becomes maximum. For example, when ABS control is actuated by the ESC 31, the ABS control is started before the driving force of the drive motor 21 becomes maximum. Therefore, the drive motor 21 does not come into the full-load state.

However, when the pedaling operation of the brake pedal 5 is performed when the vehicle is in the stopped state, the ABS control is not actuated by the ESC 31 and therefore no deceleration is generated. Thus, an excessive pedaling operation of the brake pedal 5 can be performed beyond a position at which the drive motor 21 comes into the full-load state. Therefore, when the driver further depresses the brake pedal 5 by an operation amount equal to or larger than the operation amount S1 although the booster piston 18 is stopped under the full-load state, only the input piston 19 moves forward. Therefore, the input piston 19 comes into contact with the booster piston 18 which is in a stopped state. In this case, the relationship between the operation amount S of the brake pedal 5 and the pedaling force F (that is, the pedal reaction force) abruptly changes with a so-called “spongy pedal, feeling” as represented by a characteristic line 58A indicated by the chain double-dashed line in FIG. 4. The “spongy pedal feeling” refers to a state in which a pedal stroke is made even with a small change in pedaling force. When the operation amount S becomes an operation amount S2 with which the input piston 19 comes into contact with the booster piston 18 in the stopped state, the driver has a weird pedal feeling as if the brake pedal 5 were suddenly blocked.

Therefore, in order to solve the problem described above, control processing illustrated in FIG. 5 is performed by using the second ECU 33 which is the controller for the hydraulic-pressure control unit (ESC 31) in the first embodiment. By the control processing, it is possible to suppress a reaction-force change which is caused when the drive motor 21 comes into the full-load state without lowering the output hydraulic pressure generated by the operation of the pedal.

Specifically, after the control processing illustrated in FIG. 5 starts, whether or not the pedaling operation of the brake pedal 5 is being performed is determined based on the detection signal from the brake sensor 7 (or the brake switch 6) in Step 1. While it is determined as “NO” in Step 1, the pedaling operation of the brake pedal 5 is not being performed. Therefore, the processing remains in Step 1 in a waiting state. When it is determined as “YES” in Step 1, the pedaling operation of the brake pedal 5 is being operated. Therefore, the processing proceeds to subsequent Step 2 where the pedaling operation amount S of the brake pedal 5 is calculated based on the detection signal from the brake sensor 7.

In subsequent Step 3, a necessary motor current is calculated based on the pedaling operation amount S calculated in Step 2. Specifically, the current value necessary for rotationally driving the drive motor 21 is calculated so that a movement amount of the booster piston 18 becomes a movement amount corresponding to the pedaling operation amount S of the brake pedal 5 when the drive motor 21 is rotationally driven to move the booster piston 18 into the cylinder main body 9 of the master cylinder 8.

In subsequent Step 4, whether or not the calculated value of the necessary motor current is larger than a predetermined value (for example, a current value at which the driving force of the drive motor 21 reaches the maximum driving force) is determined. The predetermined value in this case is set to a magnitude (value) at which, for example, the booster thrust to be applied from the electric actuator 20 to the booster piston 18 by the drive motor 21 rotationally driven to become a force corresponding to the pedaling force F1 shown in FIG. 4. The predetermined value cannot be achieved while the vehicle is running in the case where the drive motor 21 normally operates. In other words, when the brake pedal 5 is depressed by the amount corresponding to the predetermined value or larger, the ABS control works to stop the rotation of the drive motor 21. Therefore, while the vehicle is running on a road, the motor current does not become as large as the predetermined value.

When it is determined as “NO” in Step 4, the driving force of the drive motor 21 does not reach the maximum driving force yet (the driving motor 21 does not come into the full-load state shown in FIG. 4 yet). Thus, the processing proceeds to subsequent Step 5 where it is determined whether or not a valve-closing command has been output to the boost control valves 40 and 40′ on the wheels FL and FR (front wheels 1L and 1R) among the boost control valves 40, 40′, 41, and 41′ of the ESC 31. Whether or not the valve-closing command has been output may also be determined based on the hydraulic pressure or the pedal stroke in place of the current value output to the boost control valves 40 and 40′.

When it is determined that the valve-closing command has not been output in Step 5, the processing proceeds to subsequent Step 6 where normal brake control is performed. Specifically, in Step 6, the electric booster 16 is actuated in accordance with the pedaling operation performed on the brake pedal 5 so as to increase or reduce the hydraulic pressure in the master cylinder 8 at a predetermined boost ratio in accordance with the operation amount of the brake pedal 5. In this manner, the braking force is applied to the vehicle by the wheel cylinders 3L, 3R, 41, and 4R for the respective wheels. At this time, the relationship between the operation amount S of the brake pedal 5 and the pedaling force F (that is, the pedal reaction force) can be represented as the characteristic line 58 indicated by the solid line in FIG. 4.

Moreover, by controlling the actuation of the ESC 31 as needed, the braking-force distribution control, the anti-lock brake control, and the like can be executed. At this time, the second ECU 33 feeds the power to the electric motor 47 to actuate the hydraulic pumps 46 and 46′. As a result, the control valves 39, 39′, 40, 40′, 41, 41′, 44, 44′, 45, 45′, 52, and 52′ can be selectively opened and closed. Then, the processing returns in Step 7 to perform the control processing which starts in Step 1 again.

On the other hand, the case where it is determined that the valve-closing commands has been output in Step 5 corresponds to the following case. Specifically, for example, in a state where the valve-closing command is output in Step 10 described later, the processing returns in Step 7. Then, after the processing in Steps 1 to 5 is performed, the processing proceeds to Step 8. Therefore, in Step 8, a valve-opening command (specifically, a command to open the boost control valves 40 and 40′) is output after the output of the above-mentioned valve-closing command is stopped. Thereafter, the processing in Step 6 and subsequent steps is performed.

When it is determined as “YES” in Step 4, the driving force of the drive motor 21 has reached the maximum driving force (the drive motor 21 is in the full-load state shown in FIG. 4). Therefore, the processing proceeds to subsequent Step 9 where whether or not the vehicle is in a stopped state is determined. For example, based on the detection signals output from the wheel-speed sensors 34 (four sensors in total are illustrated in FIG. 1), whether or not the vehicle is in the stopped state can be determined.

When it is determined as “YES” in Step 9, the vehicle is in the stopped state. Therefore, the processing proceeds to subsequent Step 10 where the valve-closing command is output to, for example, the boost control valve 40 for the left front wheel FL (front wheel 1L) and the boost control valve 40′ for the right front wheel FR (front wheel 1R). In this manner, the hydraulic pressure is not supplied to the wheel cylinder 3L for the front wheel 1L and the wheel cylinder 3R for the front wheel 1R among the wheel cylinders 3L, 3R, 4L, and 4R for the respective wheels (the front wheels 1L and 1R and the rear wheels 2L and 2R) of the vehicle. Thus, the hydraulic pressure is supplied only to the wheel cylinder 4L for the rear wheel 2L and the wheel cylinder 4R for the rear wheel 2R.

Therefore, when the brake pedal 5 is depressed by a large amount while the vehicle is in the stopped state, that is, when the brake pedal 5 is depressed by the amount equal to or larger than the operation amount S1 although the drive motor 21 is in the full-load state to keep the booster piston 18 in the stopped state as represented by the characteristic line 58 shown in FIG. 4, the relationship between the operation amount S of the brake pedal 5 and the pedaling force F (that is, the pedal reaction force) changes as represented by a characteristic line 58B indicated by the solid line in FIG. 4. Thus, an abrupt change as represented by the characteristic line 58A indicated by the chain double-dashed line in FIG. 4 can be suppressed. Thus, the so-called spongy pedal feeling can be suppressed.

Specifically, in this case, by the processing in Step 10, the hydraulic pressure is not supplied to the wheel cylinder 3L for the front wheel 1L and to the wheel cylinder 3R for the front wheel 1R. Thus, the hydraulic pressure is supplied only to the wheel cylinder 4L for the rear wheel. 2L and the wheel cylinder 4R for the rear wheel 2R. Therefore, a hydraulic stiffness on the downstream side of the master cylinder can be increased. In other words, the driver who is depressing the brake pedal 5 can have a sufficiently firm pedal feeling (that is, a sufficiently large pedal reaction force generated by the pedaling force F) over a period in which the input piston 19 is moved by the operation amount S2 to reach a position at which the input piston 19 comes into contact with the booster piston 18 in the stopped state. As a result, the driver does not have a weird feeling for the pedal operation.

In Step 9, the determination as “NO” is hardly made in practice. However, when it is determined as “NO” in Step 9, the determination as “NO” means that the vehicle is not in the stopped state. Therefore, the processing proceeds to subsequent Step 6 where the normal brake control can be performed as described above. Therefore, an appropriate braking force as needed can be applied by the wheel cylinders 3L, 3R, 4L, and 4R for the respective wheels.

As described above, according to the first embodiment, even in the case where the brake pedal 5 is depressed by the amount equal to or larger than the operation amount S1 while the vehicle is in the stopped state, when the driving force of the drive motor 21 becomes the maximum driving force (that is, when the pedaling force F becomes the pedaling force F1 shown in FIG. 4 to stop the booster piston 18), the second ECU 33 outputs the valve-closing command to the boost control valve 40 for the left front wheel FL (the front wheel 1L) and the boost control valve 40′ for the right front wheel FR (the front wheel 1R), which are included in the ESC 31.

In this manner, the hydraulic pressure supplied from the master cylinder 8 through the ESC 31 toward each of the wheels is only supplied to the wheel cylinder 4L for the rear wheel 2L and the wheel cylinder 4R for the rear wheel 2P without being supplied to the wheel cylinder 3L for the front wheel 1L and the wheel cylinder 3R for the front wheel 1R. Therefore, the hydraulic stiffness on the downstream side can be increased. Specifically, the hydraulic stiffness of the wheel cylinders 3L, 3R, 4L, and 4R is changed by stopping the supply of the hydraulic fluid (brake fluid) to the wheel cylinders 3L and 3R or reducing the amount of supply of the hydraulic fluid.

As a result, even when the driver who is depressing the brake pedal 5 while the vehicle is in the stopped state depresses the brake pedal 5 by the large amount equal to or larger than the operation amount S1 shown in FIG. 4, the driver can have a sufficiently firm pedal feeling (that is, a sufficiently large pedal reaction force generated by the pedaling force F) as represented by the characteristic line 58B indicated by the solid line shown in FIG. 4 over a period in which the input piston 19 is moved by the operation amount S2 to reach a position at which the input piston 19 comes into contact with the booster piston 18 in the stopped state. Therefore, the driver does not have a weird pedal feeling for the operation of the pedal.

Moreover, inside the housing 56 which forms the outer shell for the hydraulic-pressure control unit (ESC 31), the boost control valve 40 for the left front wheel FL and the boost control valve 40′ for the right front wheel FR, to which the valve-closing commands are output from the wheel-cylinder fluid supply control unit (second ECU 33) as described above, are provided at the positions close to the side surfaces 56C and 56D which are the outer side surfaces of the housing 56. Therefore, heat from solenoids, which is generated when the boost control valves 40 and 40′ of normally-open electromagnetic valves are closed by the energization (excitation), can be released to outside air. Therefore, heat-releasing performance from the outer wall surfaces (side surfaces 56C and 56D) of the housing 56 can be enhanced.

Therefore, a structure of the brake control apparatus according to the first embodiment can be simplified. Further, the change in the reaction force (that is, the pedaling force F) when the drive motor 21 comes into the full-load state can be suppressed without lowering the output hydraulic pressure (hydraulic stiffness on the downstream side) generated by the operation of the brake pedal 5. In addition, the heat generated from the solenoids of the boost control valves 40 and 40′ can be easily released from the output wall surface (side surfaces 56C and 56D) of the housing 56.

In the first embodiment described above, the case where the boost control valve 40 for the left front wheel FL (front wheel 1L) and the boost control valve 40′ for the right front wheel FR (front wheel 1R) are closed to suppress a change in the reaction force occurring when the drive motor 21 comes into the full-load state has been described as an example. However, the present invention is not limited to the embodiment described above. For example, the boost control valve 41 for the left rear wheel RL (rear wheel 2L), the boost control valve 41′ for the right rear wheel RR (rear wheel 2R), and the boost control valve 40 for the left front wheel FL (front wheel 1L) or the boost control valve 40′ for the right front wheel FR (front wheel 1R), that is, the boost control valves for three wheels in total may be closed, whereas the boost control valve may be opened for the remaining one wheel.

For example, a characteristic line 58C indicated by the alternate long and short dash line in FIG. 4 represents the relationship between the operation amount S of the brake pedal 5 and the pedaling force F (that is, the pedal reaction force) in a state in which the brake pedal 5 is depressed by the amount equal to or larger than the operation amount S1 when the boost control valves for the three wheels in total, that is, the boost control valve 41 for the rear wheel 2L, the boost control valve 41′ for the rear wheel 2R, and the boost control, valve 40 for the front wheel 1L (or the boost control valve 40′ for the front wheel 1R) are closed and the boost control valve for the remaining one wheel is opened. Even in the case with the characteristic line 58C indicated by the alternate long and short dash line in FIG. 4, an abrupt characteristic change as represented by the characteristic line 58A indicated by the chain double-dashed line in FIG. 4 can be suppressed.

A characteristic line 58D indicated by the dotted line in FIG. 4 represents a characteristic in the case where all the boost control valves 40, 40′, 41, and 41′ for all the four wheels FL, FR, RL, and RR are closed. In the case represented by the characteristic line 58D) indicated by the dotted line, an abrupt characteristic change as represented by the characteristic line 58A indicated by the chain double-dashed line can be suppressed. On the other hand, however, the hydraulic stiffness tends to be too high.

Alternatively, in the present invention, the boost control valves for any two of the four wheels FL, FR, RL, and RR may be closed, whereas the boost control valves for the remaining two wheels may be opened. For example, the boost control valves at a side of any two of the right and left set of wheels may be closed, whereas the boost control valves for remaining two wheels may be opened. Further, the boost control valves for two cater-cornered wheels may be closed, and the boost control valves for the remaining two wheels may be opened. Furthermore, alternatively, any one of the supply control valves 39 and 39′ illustrated in FIG. 1 may be closed, whereas another thereof may be opened. On the other hand, each of the boost control valves or the supply control valves may be a flow-rate adjustable control valve. In this case, by reducing the amount of supply of the hydraulic fluid (brake fluid) to the wheel cylinders by appropriately reducing an opening degree of each of the valves, the hydraulic stiffness on the downstream side can be changed.

Further, in the present invention, when the necessary motor current (detection value) increases even after it is determined in Step 4 of FIG. 5 that “the necessary motor current is larger than the predetermined value”, the number of control valves to be closed may be increased in accordance with the increase in the necessary motor current. Even in this manner, the hydraulic stiffness of the wheel cylinders can be changed by stopping the supply of the hydraulic fluid to any of the plurality of wheel cylinders or reducing the amount of supply thereto.

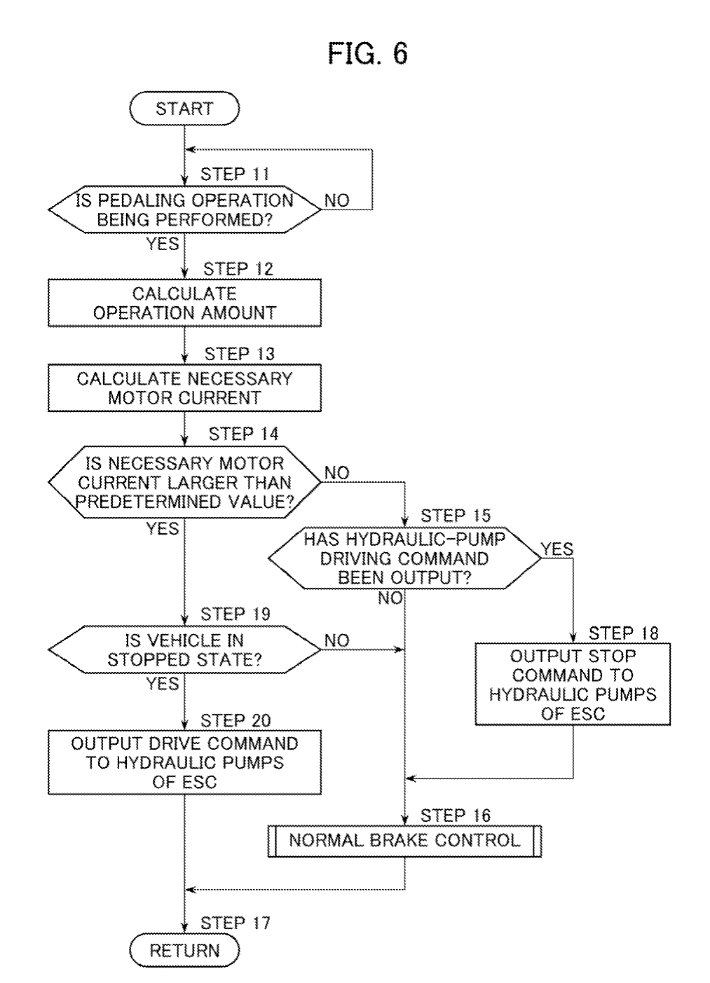

Next, FIG. 6 illustrates a second embodiment of the present invention. In the second embodiment, the same components as those of the first embodiment described above are denoted by the same reference symbols, and the description thereof is herein omitted. The feature of the second embodiment resides in that the hydraulic pumps 46 and 46′ are driven by the electric motor 47 of the ESC 31 to change the hydraulic stiffness of the wheel cylinders 3L, 3R, 4L, and 4R in order to suppress a change in the reaction force (that is, the pedaling force F) when the drive motor comes into the full-load state.

The second embodiment is to be applied to the electric booster 16 having a characteristic different from that of the first embodiment. Specifically, the electric booster 16 to which the second embodiment is to be applied presupposes the following configuration. More specifically, in order to delay the time to reach a full-load point so as to prevent the so-called spongy pedal feeling, (delay) control for reducing the amount of actuation of the primary piston (that is, the booster piston 18) to be smaller than the stroke amount of the input member (that is, the input piston 19) is performed.

Therefore, in the second embodiment, control processing illustrated in FIG. 6 is performed using the second ECU 33 which is the controller for the hydraulic-pressure control unit (ESC 31). Specifically, the hydraulic pumps 46 and 46′ are driven by the electric motor 47 of the ESC 31 to increase the hydraulic stiffness of the wheel cylinders 31, 3R, 4L, and 4R so that a ratio of the operation amount (pedal stroke) to the pedaling force at the time of the operation of the pedal is not reduced. In this manner, a change in the reaction force, which is generated when the drive motor comes into the full-load state, can be suppressed.

Specifically, after the control processing illustrated in FIG. 6 is started, processing in Steps 11 to 14 is performed in the same manner as in Steps 1 to 4 illustrated in FIG. 5, which is described above in the first embodiment. When it is determined as “NO” in Step 14, however, the driving force of the drive motor 21 does not reach the maximum driving force yet (the drive motor 21 does not come into the full-load state shown in FIG. 4 yet). Therefore, the processing proceeds to subsequent Step 15 where it is determined whether or not the drive command has been output to the hydraulic pumps 46 and 46′ (specifically, the electric motor 47) of the ESC 31.

When it is determined that the drive command has not been output to the hydraulic pumps 46 and 46′ (that is, the electric motor 47) in Step 15, the processing proceeds to Step 16 where the normal brake control is performed. For the normal brake control, the same processing as that performed in Step 6 illustrated in FIG. 5, which is described above in the first embodiment, is performed.

On the other hand, the case where it is determined that the drive command has been output in Step 15 corresponds to, for example, the following case. Specifically, the processing returns in Step 17 in a state in which the drive command is output to the hydraulic pumps 46 and 46′ (electric motor 47) in Step 20 described later. After the processing in Steps 11 to 15 is performed, the processing proceeds to Step 18. Therefore, in Step 18, after the above-mentioned drive command to the electric motor 47 is stopped, the processing in next Step 16 and subsequent steps is executed.

Next, when it is determined as “YES” in Step 14, the driving force of the drive motor 21 reaches the maximum driving force (the drive motor 21 comes into the full-load state shown in FIG. 4). Thus, the processing proceeds to subsequent Step 19 where it is determined whether or not the vehicle is in the stopped state. When it is determined as “YES” in Step 19, the vehicle is in the stopped state. Therefore, the processing proceeds to subsequent Step 20 where the drive command is output to the hydraulic pumps 46 and 46′ (electric motor 47) of the ESC 31.

In the above-mentioned manner, the electric motor 47 of the ESC 31 rotationally drives the hydraulic pumps 46 and 46′. As a result, for example, the hydraulic pumps 46 and 46′ discharge the brake fluid, which is pumped into from the reservoirs 51 and 51′ for hydraulic-pressure control, to the brake pipeline 36 and 36′, the first pipeline portions 37 and 37′, and the second pipeline portions 38 and 38′ while supplying the hydraulic pressure to the wheel cylinders 3L, 3R, 4L, and 4R through the boost control valves 40, 40′, 41, and 41′ and the brake-side pipeline portions 32A, 32B, 32C, and 32D.

As a result, even when the driver who is depressing the brake pedal 5 while the vehicle is in the stopped state depresses the brake pedal 5 by the large amount equal to or larger than the operation amount S1 shown in FIG. 4, the hydraulic stiffness on the downstream side can be increased by the hydraulic pressure supplied from the hydraulic pumps 46 and 46′ to the wheel cylinders 3L, 3R, 4L, and 4R. As a result, a change in the reaction force, which is generated when the drive motor 21 comes into the full-load state, can be suppressed. When it is determined as “NO” in Step 19, the vehicle is not in the stopped state. Thus, the processing proceeds to subsequent Step 16 where the normal brake control can be performed as described above. Thus, an appropriate braking force as needed can be applied to the wheel cylinders 3L, 3R, 4L, and 4R for the respective wheels.

In the above-mentioned manner, even in the second embodiment having the configuration described above, when the driver depresses the brake pedal by a large amount to increase the driving force of the drive motor 21 of the electric booster 16 to the maximum driving force while the vehicle is in the stopped state, the hydraulic pumps 46 and 46′ can be driven by the electric motor 47 of the ESC 31 to change the hydraulic stiffness of the wheel cylinders 3L, 3R, 4L, and 4R. As a result, a change in the reaction force (that is, the pedaling force F), which is generated when the drive motor 21 comes into the full-load state, can be suppressed.

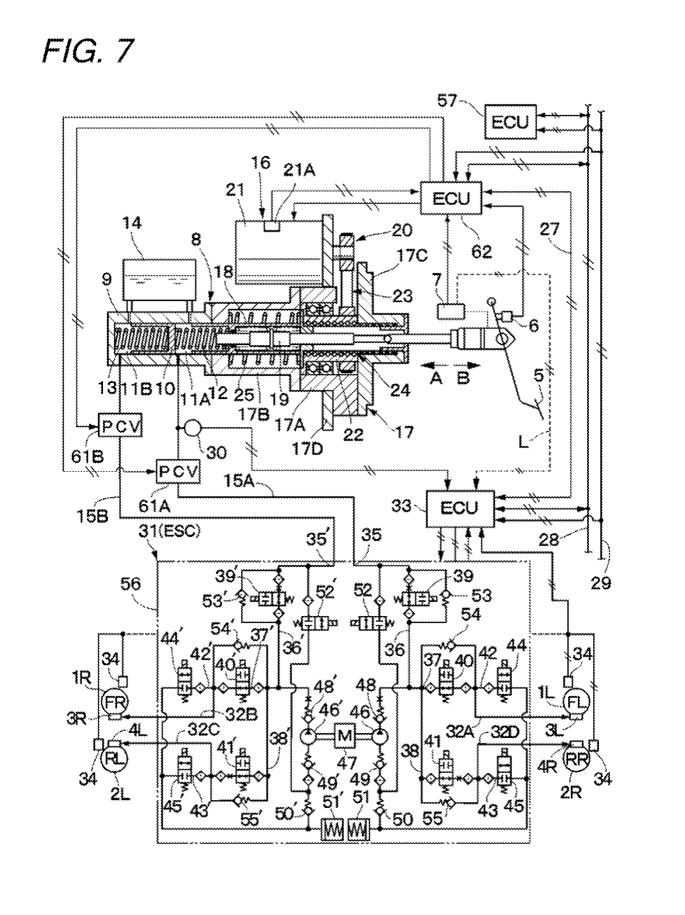

Next, FIG. 7 illustrates a third embodiment of the present invention. In the third embodiment, the same components as those of the first embodiment described above are denoted by the same reference symbols, and the description thereof is herein omitted. The feature of the third embodiment resides in that, in order to suppress a change in the reaction force (that is, the pedaling force F), which is generated when the drive motor comes into the full-load state, the hydraulic stiffness of the wheel cylinders 3L, 3R, 4L, and 4R is changed by variably controlling the brake fluid pressure by using pressure control valves 61A and 61B as the wheel-cylinder fluid supply control unit.

Here, the pressure control valves 61A and 61B are generally referred to as proportioning valves. The proportioning valve controls a pressure so that a discharge pressure toward the downstream side is reduced at a constant rate with respect to an input pressure. The pressure control valve 61A is provided in the cylinder-side hydraulic pipe 15A which connects the first hydraulic chamber 11A of the master cylinder 8 and the ESC 31 (hydraulic-control unit). Similarly, the pressure control valve 61B is provided in the cylinder-side hydraulic pipe 15B which connects the second hydraulic chamber 11B and the ESC 31. The pressure control valves 61A and 61B constitute the wheel-cylinder fluid supply control unit. By the control signal output from a first ECU 62, the pressure control valve 61A variably controls the hydraulic pressure in the cylinder-side hydraulic pipe 15A, while the pressure control valve 61B variably controls the hydraulic pressure in the cylinder-side hydraulic pipe 15B.

The first ECU 62 is configured in the same manner as in the case of the first ECU 26 described in the first embodiment and functions as a controller (control device) for the electric booster, which electrically controls the drive of the electric actuator 20 (drive motor 21) of the electric booster 16. However, an output side of the first ECU 62 is connected to the pressure control valves 61A and 61B in addition to the drive motor 21 so that the first ECU 62 has a function of outputting the control signal for increasing the hydraulic stiffness to the pressure control valves 61A and 61B.

Therefore, when the driving force of the drive motor 21 of the electric booster 16 becomes the maximum driving force (that is, the hydraulic pressure to be applied become a full-load hydraulic pressure) while the brake pedal 5 is being operated, the pressure control valves 61A and 61B perform pressure-reduction control (control for reducing an opening degree of each of the valves) on the hydraulic pressure to be supplied to the downstream side of the cylinder-side hydraulic pipes 15A and 15B in accordance with the control signal from the first ECU 62. In this manner, the hydraulic stiffness of the wheel cylinders 3L, 3R, 4L, and 4R can be increased to be larger than that of the master cylinder 8.

As described above, even in the third embodiment having the configuration described above, when the driver depresses the brake pedal 5 by a large amount while the vehicle is in the stopped state to increase the driving force of the drive motor 21 of the electric booster 16 to the maximum driving force, the hydraulic pressure to be supplied to the downstream side of the cylinder-side hydraulic pipes 15A and 25B is controlled by the pressure control valves 61A and 61B to change the hydraulic stiffness of the wheel cylinders 3L, 3R, 4L, and 4R. As a result, a change in the reaction force (that is, the pedaling force F) when the drive motor 21 comes into the full-load state can be suppressed.

In the third embodiment described above, the case where the pressure control valves 61A and 61B called “proportioning valves” are provided in the middle of the cylinder-side hydraulic pipes 15A and 15B is described as an example. However, the present invention is not limited to the above-mentioned embodiment. For example, on-off valves such as electromagnetic valves to be controlled to be opened or closed may be provided in the middle of the cylinder-side hydraulic pipes 15A and 15B.

Next, the invention encompassed in each of the embodiments described above is described. According to the present invention, the hydraulic stiffness of the wheel cylinder is increased by reducing the supply of the hydraulic fluid to the wheel cylinder. Moreover, the hydraulic stiffness of the wheel cylinder is changed by stopping the supply of the hydraulic fluid to any of the plurality of wheel cylinders.

On the other hand, the brake control apparatus of the present invention includes the master-cylinder pressure control unit which controls the drive motor configured to pressurize the hydraulic fluid of the master cylinder by the operation of the brake pedal to which the hydraulic reaction force is transmitted, and the wheel-cylinder fluid supply control unit provided between the wheel cylinder provided to the wheel and the master cylinder, which controls the supply of the hydraulic fluid to the wheel cylinder. During the operation of the brake pedal while the vehicle is in the stopped state, the hydraulic stiffness of the wheel cylinder is changed by the wheel-cylinder fluid control unit.

In this case, the hydraulic stiffness of the wheel cylinder is changed at least when the output of the drive motor becomes the maximum output while the vehicle is in the stopped state. Moreover, the hydraulic stiffness of the wheel cylinder is changed by reducing the supply of the hydraulic fluid to the wheel cylinder. Moreover, the hydraulic stiffness of the wheel cylinder is changed by stopping the supply of the hydraulic fluid to any of the plurality of wheel cylinders.

According to the brake control apparatus of the present invention, the wheel cylinders to which the supply of the hydraulic fluid is stopped are the wheel cylinders for the front wheels. Moreover, the master-cylinder pressure control unit is the controller for the electric booster which thrusts the piston of the master cylinder by the rotating force of the drive motor. Further, the wheel-cylinder fluid supply control unit is the controller for the hydraulic-pressure control unit, which is provided between the master cylinder and the wheel cylinders and controls the communication and interruption of the fluid paths by the electromagnetic valves.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority to Japanese Patent Applications No. 2013-180389 filed on Aug. 30, 2013. The entire disclosures of No. 2013-180389 filed on Aug. 30, 2013 including specification, claims, drawings and summary are incorporated herein by reference in its entirety.

What is claimed is:

1. A brake control apparatus, comprising:
a master-cylinder pressure control unit configured to control a drive motor configured to pressurize a hydraulic fluid in a master cylinder in accordance with an operation of a brake pedal;
a wheel-cylinder fluid supply control unit provided between a wheel cylinder provided to a wheel of a vehicle and the master cylinder, the wheel-cylinder fluid supply control unit being configured to control supply of the hydraulic fluid to the wheel cylinder; and
a transmission unit configured to transmit a hydraulic reaction force in accordance with a hydraulic pressure in the master cylinder to the brake pedal,
wherein the wheel-cylinder fluid supply control unit amends a hydraulic stiffness of the wheel cylinder in a period during which the brake pedal is operated while the vehicle is in a stopped state.

2. A brake control apparatus according to claim 1, wherein the wheel-cylinder fluid supply control unit amends the hydraulic stiffness of the wheel cylinder at least when an output of the drive motor becomes a maximum output while the vehicle is in the stopped state.

3. A brake control apparatus according to claim 2, wherein the wheel-cylinder fluid supply control unit amends the hydraulic stiffness of the wheel cylinder at least when a hydraulic pressure value of the master cylinder reaches a hydraulic pressure value at which the output of the drive motor becomes the maximum output while the vehicle is in the stopped state.

4. A brake control apparatus according to claim 2, wherein the wheel-cylinder fluid supply control unit amends the hydraulic stiffness of the wheel cylinder at least when a current value of the drive motor reaches a current value at which the output of the drive motor becomes the maximum output while the vehicle is in the stopped state.

5. A brake control apparatus according to claim 2, wherein the wheel-cylinder fluid supply control unit amends the hydraulic stiffness of the wheel cylinder at least when an operation amount of the brake pedal reaches an operation amount at which the output of the drive motor becomes the maximum output while the vehicle is in the stopped state.

6. A brake control apparatus according to claim 1, wherein the wheel-cylinder fluid supply control unit amends the hydraulic stiffness of the wheel cylinder by reducing an amount of the supply of the hydraulic fluid to the wheel cylinder.

7. A brake control apparatus according to claim 6, wherein the wheel-cylinder fluid supply control unit amends the hydraulic stiffness of the wheel cylinder by stopping the supply of the hydraulic fluid to one of a plurality of the wheel cylinders.

8. A brake control apparatus according to claim 7, wherein the one of the plurality of the wheel cylinders to which the supply of the hydraulic fluid is stopped is a wheel cylinder for a front wheel of the vehicle.

9. A brake control apparatus according to claim 1, wherein the master-cylinder pressure control unit comprises a controller for an electric booster configured to thrust a piston of the master cylinder by a rotating force of the drive motor.

10. A brake control apparatus according to claim 1, wherein the wheel-cylinder fluid supply control unit comprises a controller for a hydraulic-pressure control unit provided in a fluid path between the master cylinder and the wheel cylinder and configured to control communication and interruption of the fluid path by an electromagnetic valve.

11. A brake control apparatus according to claim 10, wherein:
the hydraulic-pressure control unit comprises a pump configured to supply the hydraulic fluid to the wheel cylinder; and
the wheel-cylinder fluid supply control unit changes the hydraulic stiffness of the wheel cylinder by increasing the supply of the hydraulic fluid to the wheel cylinder by the pump.

12. A brake control apparatus according to claim 1, wherein the wheel-cylinder fluid supply control unit comprises a controller for a pressure control valve provided in a fluid path between the master cylinder and the wheel cylinder and configured to control communication and interruption of the fluid path by an electromagnetic valve.

13. A brake control apparatus, comprising:
a master-cylinder pressure control unit configured to control a drive motor configured to pressurize a hydraulic fluid in a master cylinder in accordance with an operation of a brake pedal to which a hydraulic reaction force is transmitted; and
a wheel-cylinder fluid supply control unit provided between a wheel cylinder provided to a wheel of a vehicle and the master cylinder, the wheel-cylinder fluid supply control unit being configured to control supply of the hydraulic fluid to the wheel, cylinder,
wherein the wheel-cylinder fluid supply control unit controls the supply of the hydraulic fluid so as to increase a hydraulic stiffness of the wheel cylinder when a driving force of the drive motor becomes a maximum driving force in a period during which the brake pedal is operated.

14. A brake control apparatus according to claim 13, wherein the wheel-cylinder fluid supply control unit performs the control so as to reduce an amount of the supply of the hydraulic fluid to the wheel cylinder to increase the hydraulic stiffness of the wheel cylinder.

15. A brake control apparatus according to claim 13, wherein the wheel-cylinder fluid supply control unit amends the hydraulic stiffness of the wheel cylinder by stopping the supply of the hydraulic fluid to one of a plurality of the wheel cylinders.

16. A brake control apparatus according to claim 15, wherein the one of the plurality of the wheel cylinders to which the supply of the hydraulic fluid is stopped is a wheel cylinder for a front wheel of the vehicle.

17. A brake control apparatus according to claim 13, wherein the master-cylinder pressure control unit comprises a controller for an electric booster configured to thrust a piston of the master cylinder by a rotating force of the drive motor.

18. A brake control apparatus according to claim 13, wherein the wheel-cylinder fluid supply control, unit comprises a controller for a hydraulic-pressure control unit provided between the master cylinder and the wheel cylinder and configured to control communication and interruption of a fluid path by an electromagnetic valve.

19. A brake control apparatus, comprising:
a master-cylinder pressure control unit configured to control a drive motor configured to pressurize a hydraulic fluid in a master cylinder in accordance with an operation of a brake pedal;
a wheel-cylinder fluid supply control unit provided in a fluid path between the master cylinder and each of wheel cylinders provided to wheels of a vehicle, the wheel-cylinder fluid supply control unit being configured to control a plurality of electromagnetic valves configured to allow and interrupt the supply of the hydraulic fluid to the wheel cylinders; and
a transmission unit configured to transmit a hydraulic reaction force in accordance with a hydraulic pressure in the master cylinder to the brake pedal,
wherein the wheel-cylinder fluid supply control unit closes one of the plurality of electromagnetic valves when a driving force of the drive motor becomes a maximum driving force in a period during which the brake pedal is operated while the vehicle is in a stopped state.

20. A brake control apparatus according to claim 19, wherein the wheel-cylinder fluid supply control unit closes one of the plurality of electromagnetic valves provided in the fluid path to the wheel cylinder for a front wheel of the vehicle.
